(19) United States
(12) Patent Application Publication
(10) Pub. No.: US 2008/0107923 A1
(43) Pub. Date: May 8, 2008

(54) ELECTRODE ARRANGEMENT FOR GAS SENSORS

(76) Inventors: David P. Wallace, Shelby, OH (US); Paul C. Kikuchi, Fenton, MI (US)

Correspondence Address: CANTOR COLBURN, LLP, 20 Church Street, 22nd Floor, Hartford, CT, 06103, US

(21) Appl. No.: 11/557,839

(22) Filed: Nov. 8, 2006

(51) Int. Cl. H01M 14/00; H01M 6/18

(52) U.S. Cl. 429/8; 429/209

(57) ABSTRACT

An electrochemical cell, comprising: an electrolyte having a first active exterior surface and a second active exterior surface aligned with the first active exterior surface; a first electrode having a main contact surface area disposed on the first active exterior surface of the electrolyte, wherein the main contact surface area of the first electrode defines a conductive path that does not completely cover the first active exterior surface; a second electrode disposed on the second active exterior surface of the electrolyte; and wherein, the electrochemical cell's resistance to oxygen ions is less than an electrochemical cell having a pair of electrodes configured to cover a greater percentage of the first and second active exterior surface areas.

### TECHNICAL FIELD

Exemplary embodiments of the present invention relate to an electrode arrangement. More particularly, exemplary embodiments of the present invention relate to electrode arrangements for use with a gas sensor.

### BACKGROUND

An electrochemical cell comprises two electrodes and an electrolyte, wherein the active portion of the electrolyte is covered on two sides by electrodes, which serve to catalyze gases or liquids as well as provide an electrically conductive path for a signal and a current.

The active portion of the electrolyte is also covered completely or 100% of the active area of the electrolyte is covered by the electrodes.

In one application, an exhaust gas sensor is configured to use an electrochemical cell to sense the composition of an exhaust gas. In this application, the sensor is configured to detect the presence of certain gases, for example, oxygen. As such, the sensor can be used to determine the exhaust gas content for alteration and optimization of an air to fuel ratio of an internal combustion engine producing the exhaust gas.

In accordance with known principles, an ionically conductive solid electrolyte is located between a pair of electrodes. For oxygen, solid electrolyte sensors are used to measure oxygen activity differences between an unknown gas sample and a known gas sample. In one approach, the unknown gas is an engine exhaust and the known gas, (i.e., reference gas), is usually atmospheric air because the oxygen content in air is relatively constant and readily accessible. This type of sensor is based on an electrochemical galvanic cell operating in a potentiometric mode to detect the relative amounts of oxygen present in the engine's exhaust. When opposite surfaces of this galvanic cell are exposed to different oxygen partial pressures, an electromotive force (“emf”) is developed between the electrodes according to the Nernst equation.

With the Nernst principle, chemical energy is converted into electromotive force. A gas sensor based upon this principle typically consists of an ionically conductive solid electrolyte material, a porous electrode with a porous protective overcoat exposed to exhaust gases (“exhaust gas electrode”), and a porous electrode exposed to a known gas' partial pressure (“reference electrode”). In one example, a yttria stabilized zirconia based electrochemical galvanic cell with porous platinum electrodes, operating in potentiometric mode is used to detect the relative amounts of a particular gas, such as oxygen. In addition, such a sensor also uses a ceramic heater attached to maintain the sensor's ionic conductivity at lower exhaust temperatures. When opposite surfaces of the galvanic cell are exposed to different oxygen partial pressures, an electromotive force is developed between the electrodes on the opposite surfaces of the zirconia wall, according to the Nernst equation:

$$E = ( \frac{- RT}{4 F} ) ln ( \frac{{P}_{{O}_{2}}^{ref}}{{P}_{{O}_{2}}} )$$

where:
E=electromotive force
R=universal gas constant
F=Faraday constant
T=absolute temperature of the gas
P_{O}_{₂}^{ref}=oxygen partial pressure of the reference gas
P_{O}_{₂}=oxygen partial pressure of the exhaust gas

Due to the large difference in oxygen partial pressure between fuel rich and fuel lean exhaust conditions, the electromotive force (emf) changes sharply at the stoichiometric point, giving rise to the characteristic switching behavior of these sensors. Consequently, these potentiometric oxygen sensors indicate qualitatively whether the engine is operating fuel-rich or fuel-lean, conditions without quantifying the actual air-to-fuel ratio of the exhaust mixture.

In one such sensor, the sensor comprises a first electrode capable of sensing an exhaust gas and a second electrode capable of sensing a reference gas with an ionically conductive solid electrolyte disposed therebetween.

In addition, the materials typically used for the electrodes are precious materials (e.g., platinum) thus the more material used for the electrode the higher the cost.

Accordingly, it is desirable to provide an electrode arrangement for a gas sensor wherein the amount of material used for the electrode is reduced without adversely affecting the performance of the sensor.

### SUMMARY OF THE INVENTION

In one exemplary embodiment, an electrochemical cell is provided. The electrochemical cell comprising: an electrolyte having a first active exterior surface and a second active exterior surface aligned with the first active exterior surface; a first electrode having a main contact surface area disposed on the first active exterior surface of the electrolyte, wherein the main contact surface area of the first electrode defines a conductive path that does not completely cover the first active exterior surface; a second electrode disposed on the second active exterior surface of the electrolyte; and wherein, the electrochemical cell's resistance to oxygen ions is less than an electrochemical cell having a pair of electrodes configured to cover a greater percentage of the first and second active exterior surface areas.

In another exemplary embodiment, a gas sensor is provided. The gas sensor comprising: an electrochemical cell, the electrochemical cell comprising: an electrolyte having a first active exterior surface and a second active exterior surface aligned with the first active exterior surface; a first electrode having a main contact surface area disposed on the first active exterior surface of the electrolyte, wherein the main contact surface area of the first electrode defines a conductive path that does not completely cover the first active exterior surface; a second electrode disposed on the second active exterior surface of the electrolyte, the second electrode being positioned to be in fluid communication with a gas; and wherein, the electrochemical cell's resistance to oxygen ions is less than an electrochemical cell having a pair of electrodes configured to cover a greater percentage of the first and second active exterior surface areas.

In yet another exemplary embodiment, a method for reducing the resistance of an electrochemical cell to oxygen ions is provided. The method comprising: positioning an electrolyte having a first active exterior surface and a second active exterior surface aligned with the first active exterior surface between a first electrode and a second electrode, the first electrode having a main contact surface area disposed on the first active exterior surface of the electrolyte, wherein the main contact surface area of the first electrode defines a conductive path that does not completely cover the first active exterior surface and the second electrode is disposed on the second active exterior surface of the electrolyte, the second electrode being configured to be positioned in fluid communication with a gas; and wherein, the electrochemical cell's resistance to oxygen ions is less than an electrochemical cell having a pair of electrodes configured to cover a greater percentage of the first and second active exterior surface areas.

### BRIEF DESCRIPTION OF THE DRAWINGS

FIG. 1 is an exploded view of a sensor comprising an electrochemical cell;

FIG. 2 are schematic illustrations of electrodes contemplated for use with exemplary embodiments of the present invention;

FIG. 3 is a graph illustrating an electrochemical cell's resistance to oxygen ions using reduced electrode coverage patterns; and

FIG. 4 are schematic illustrations of alternative electrode patterns contemplated for use with electrochemical cells in accordance with exemplary embodiments of the present invention.

### DETAILED DESCRIPTION OF EXEMPLARY EMBODIMENTS

In accordance with an exemplary embodiment of the present invention a reduced coverage electrode is provided. The reduced coverage electrode allows for less precious material to be used thus resulting in less material cost. In addition, and in accordance with an exemplary embodiment of the present invention, the reduced coverage electrode provides at least the same performance as a full coverage electrode. In addition, and in accordance with an exemplary embodiment the reduced coverage electrode also provides an electrochemical cell wherein the electrolyte layer's resistance to oxygen ions is less than an electrochemical cell having a pair of electrodes configured to cover a greater percentage of the active surface areas of the electrolyte.

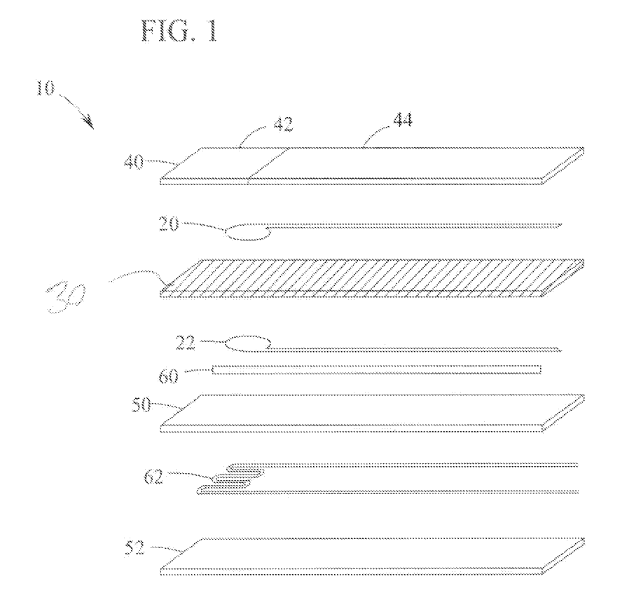

Referring now to FIG. 1, the construction of a sensor element 10 is illustrated. Here an exhaust gas (or outer) electrode 20 and a reference gas (or inner) electrode 22 are disposed on opposite sides of, and adjacent to, a solid electrolyte layer 30 creating an electrochemical cell (20/30/22).

Disposed over the gas electrode is a protective insulating layer 40. Protective insulating layer 40 comprises a porous section 42 and a dense section 44. The porous section enables fluid communication between the exhaust gas electrode and exhaust gas into which the sensor is located.

On the opposite side of the electrolyte layer is a gas channel 60 that is positioned to provide fluid communication to the reference electrode 22. As such, the gas channel provides fluid communication with a reference gas such as ambient atmosphere.

In addition, and proximate to the reference electrode a heater 62 is located. Heater 62 provides a means for maintaining sensor element 10 at a desired operating temperature. Disposed between the reference gas channel and the heater, as well as on a side of the heater opposite the reference gas channel, are one or more insulating layers 50, 52.

In addition to the above sensor components, conventional components can be employed, including but not limited to, lead gettering layer(s), leads, contact pads, ground plane(s), support layer(s), additional electrochemical cell(s), and the like. The leads (not shown), which supply current to the heater and electrodes, are typically formed on the same layer as the heater/electrode to which they are in electrical communication and extend from the heater/electrode to the terminal end of the gas sensor where they are in electrical communication with the corresponding via (not shown) and appropriate contact pads (not shown).

Insulating layers 50, 52, and protective layer 40, provide structural integrity (e.g., protect various portions of the gas sensor from abrasion and/or vibration, and the like, and provide physical strength to the sensor), and physically separate and electrically isolate various components. The insulating layer(s), which can be formed using ceramic tape casting methods or other methods such as plasma spray deposition techniques, screen printing, stenciling and others conventionally used in the art, can each be up to about 200 microns (μm) thick or so, with a thickness of about 50 μm to about 200 μm preferred. Since the materials employed in the manufacture of gas sensors preferably comprise substantially similar coefficients of thermal expansion, shrinkage characteristics, and chemical compatibility in order to minimize, if not eliminate, delamination and other processing problems, the particular material, alloy or mixture chosen for the insulating and protective layers is dependent upon the specific electrolyte employed. Typically these insulating layers comprise a dielectric material such as alumina, and the like.

In accordance with an exemplary embodiment, heater 62 is employed to maintain the sensor element at the desired operating temperature and can comprise any materials capable for maintaining the sensor at a required temperature in order to facilitate the various electrochemical reactions therein. For example, heater 62 may comprise platinum, aluminum, palladium, and the like, as well as mixtures, oxides, and alloys comprising at least one of the foregoing metals, or any other conventional heater, that is generally screen printed or otherwise disposed onto a substrate to a thickness of about 5 μm to about 50 μm wherein an applied current will produce the desired effect.

The heater maintains the electrochemical cell (electrodes 20, 22 and electrolyte 30) at a desired operating temperature. The electrolyte layer 30 can be solid or porous, can comprise the entire layer or a portion thereof, can be any material that is capable of permitting the electrochemical transfer of oxygen ions, should have an ionic/total conductivity ratio of approximately unity, and should be compatible with the environment in which the gas sensor will be utilized (e.g., up to about 1,000° C.). Possible electrolyte materials can comprise any material conventionally employed as sensor electrolytes, including, but not limited to, zirconia which may optionally be stabilized with calcium, barium, yttrium, magnesium, aluminum, lanthanum, cesium, gadolinium, and the like, as well as oxides, alloys, and combinations comprising at least one of the foregoing materials. For example, the electrolyte can be alumina and/or yttrium stabilized zirconia. Typically, the electrolyte, which can be formed via many conventional processes (e.g., die pressing, roll compaction, stenciling and screen printing, tape casting techniques, and the like), has a thickness of up to about 500 μm or so, with a thickness of about 25 μm to about 500 μm preferred, and a thickness of about 50 μm to about 200 μm especially preferred.

It should be noted that the electrolyte layer 30 and porous section 42 can comprise an entire layer or a portion thereof; e.g., they can form the layer, be attached to the layer (porous section/electrolyte abutting dielectric material), or disposed in an opening in the layer (porous section/electrolyte can be an insert in an opening in a dielectric material layer). The latter arrangement eliminates the use of excess electrolyte and protective material, and reduces the size of gas sensor by eliminating layers. Any shape can be used for the electrolyte and porous section, with the size and geometry of the various inserts, and therefore the corresponding openings, being dependent upon the desired size and geometry of the adjacent electrodes. It is preferred that the openings, inserts, and electrodes have a substantially compatible geometry such that sufficient exhaust gas access to the electrode(s) is enabled and sufficient ionic transfer through the electrolyte is established.

The electrodes 20, 22, are disposed in ionic contact with the electrolyte layer 30. Conventional electrodes can comprise any catalyst capable of ionizing oxygen, including, but not limited to, platinum, palladium, osmium, rhodium, iridium, gold, ruthenium, zirconium, yttrium, cerium, calcium, aluminum, silicon, and the like, and oxides, mixtures, and alloys comprising at least one of the foregoing catalysts. As with the electrolyte, the electrodes 20, 22 can be formed using conventional techniques. Some possible techniques include sputtering, painting, chemical vapor deposition, screen printing, and stenciling, among others. If a co-firing process is employed for the formation of the sensor, screen printing the electrodes onto appropriate tapes is preferred due to simplicity, economy, and compatibility with the co-fired process. Electrode leads and vias (not shown) in the insulating and/or electrolyte layers are typically formed simultaneously with electrodes.

Following the formation of the sensing element 10, a protective coating can be applied to the sensing element 10. This protective coating may optionally be used to coat the entire sensing element 10 or a portion of the sensing element 10. Conventional protective coatings are formed of a composition comprising a metal oxide and a fugitive material. Metal oxides having an affinity to filter out materials such as silica and zinc phosphate compounds, and other poisons, as well as having a high temperature stability (e.g., up to about 900° C. or so), and preferably having a high surface area (e.g., a surface area of about 50 m²/g or greater, with about 100 m²/g or greater preferred). Some possible metal oxides can include alumina, silica, and the like, and mixtures comprising at least one of the foregoing metal oxides. Conventional fugitive materials include carbon-based materials, such as carbon black. As used herein, a “fugitive material” means a material that will occupy space until the electrode is fired, thus leaving porosity in the coating.

An exemplary embodiment of the present invention will now be described. Here the electrochemical cell has reduced electrode coverage on a surface or both surface of the electrolyte. In other words, the electrode covers a surface area that is less than a surface area of the surface of the electrolyte. As will be described in much further detail, by reducing the electrode coverage on the surface of the electrolyte, the electrical resistance of the electrolyte cell actually goes down as the electrode coverage is reduced.

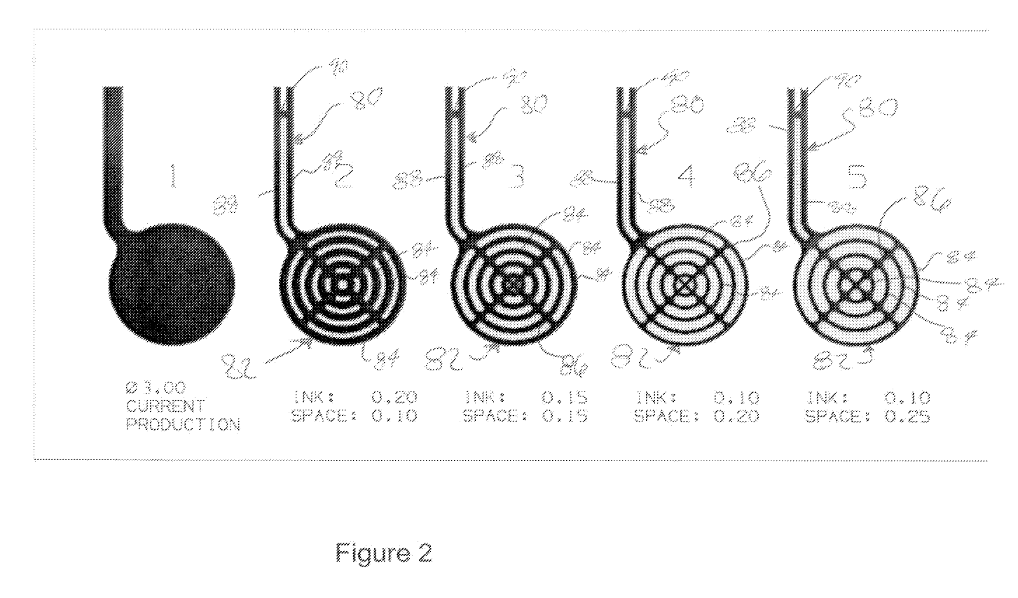

Referring now to FIG. 2, several electrode patterns are illustrated. Here a first pattern comprising a full coverage electrode is illustrated as electrode pattern 1 while other electrode patterns of varying reduced coverage are illustrated as electrode pattern 2, electrode pattern 3, electrode pattern 4 and electrode pattern 5.

As clearly illustrated, the amount of electrode material decreases when viewed from pattern 2 through 5. Also, noted in FIG. 2 is that the width of the electrode material and the gaps between the electrode material is provided in millimeters, which is after the firing process step.

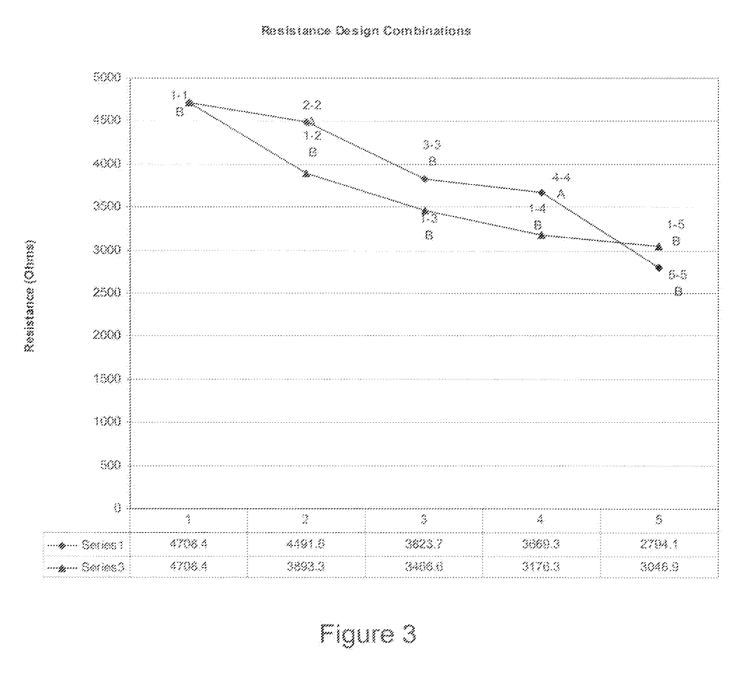

Referring now to FIGS. 2 and 3, a graph of an oxygen ion resistance test is illustrated using sensors with electrodes of varying electrode areas, namely the patterns shown in FIG. 2. Here the electrical resistance to oxygen measured in ohms is shown to decrease as the electrode area decreases. When referring to the graph of FIG. 3, numbers represent the patterns used for the electrode (illustrated in FIG. 2) and the first number or the number on the left hand side is the exhaust side electrode or the electrode exposed to the exhaust gases while the number on the right is the air reference electrode. For example, the data point 1-2 indicates data collected when the exhaust side electrode had a full coverage or pattern 1 from FIG. 2 and reference side electrode had pattern 2 or reduced coverage electrode illustrated in FIG. 2.

As clearly shown when the coverage of the air reference electrode is reduced and the exhaust side electrode remains the same or fully covered there is a direct correlation to a reduction of the resistance to oxygen measured in ohms.

In addition, and when both the air reference electrode and exhaust side electrode coverage is reduced again there is a direct correlation to a reduction of the resistance to oxygen measured in ohms.

Accordingly, and as the coverage of the electrodes of the electrochemical cell are reduced the cell experiences a reduced resistance to oxygen ions. Thus, providing a more sensitive electrochemical cell while also decreasing the associated material cost for electrodes comprising precious metals.

Thus, exemplary embodiments of the present invention provide substantial advantages over existing electrochemical cells in that the electrochemical cell with reduced electrode coverage can have reduced electrical resistance between the electrodes while utilizing less electrode material. By utilizing less electrode material, electrochemical cells with reduced electrode coverage can be manufactured at lower costs than existing electrochemical cells. By having reduced electrical resistance, electrochemical cells can generate increased voltage levels. By generating increased voltage levels, the electrochemical cell with reduced electrode coverage can produce power more efficiently than existing electrochemical cells. Further, by generating increased voltage levels, gas sensors utilizing the electrochemical cell with reduced electrode coverage can detect gas levels more accurately.

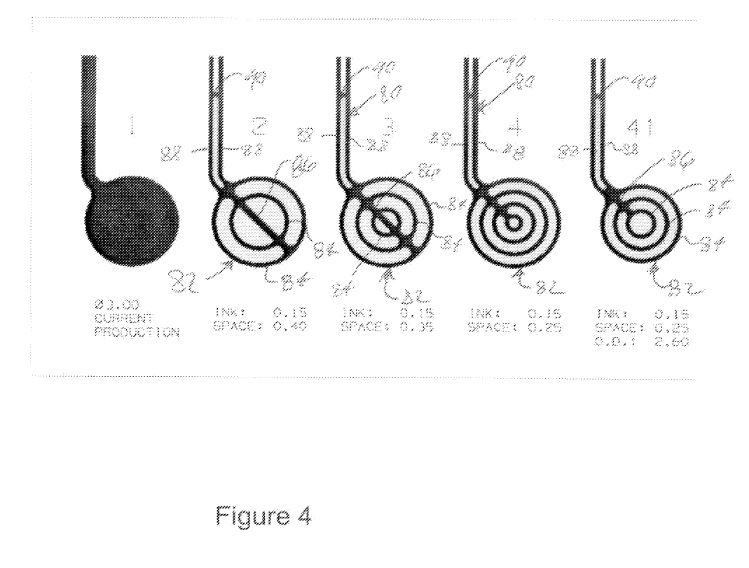

Of course, exemplary embodiments of the present invention are not limited to the patterns illustrated in FIG. 2. For example, other non-limiting electrode patterns are illustrated in FIG. 4. In addition, and referring now to FIGS. 2 and 4 it is also noted that the lead area 80 to a main contact surface area 82 may also be configured to have a reduced coverage area or gap disposed therebetween. In accordance with an exemplary embodiment, and referring now to FIG. 2, each of the reduce area electrodes comprises a plurality of spaced apart concentric rings 84 wherein at least one conductive path is provided therebetween by a conductive portion 86 that makes electrical contact with each of the plurality of concentric rings. In addition, lead area 80 may be further defined by a pair of spaced apart conductive paths 88 each of which makes electrical contact with at least one of the conductive concentric rings. Also, a bridging member 90 may also provide another conductive path therebetween.

Also, noted in FIG. 4 is that the width of the electrode material and the gaps between the electrode material is provided in millimeters, which is after the firing process step. Of course, dimensions greater or less than those illustrated in FIGS. 2 and 4 are contemplated to be within the scope of exemplary embodiments of the present invention.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An electrochemical cell, comprising:
an electrolyte having a first active exterior surface and a second active exterior surface aligned with the first active exterior surface;
a first electrode having a main contact surface area disposed on the first active exterior surface of the electrolyte, wherein the main contact surface area of the first electrode defines a conductive path that does not completely cover the first active exterior surface;
a second electrode disposed on the second active exterior surface of the electrolyte; and
wherein, the electrochemical cell's resistance to oxygen ions is less than an electrochemical cell having a pair of electrodes configured to cover a greater percentage of the first and second active exterior surface areas.

2. The electrochemical cell as in claim 1, wherein the second electrode has a main contact surface area disposed on the second active exterior surface of the electrolyte, wherein the main contact surface area of the second electrode defines a conductive path that does not completely cover the second active exterior surface.

3. The electrochemical cell as in claim 2, wherein the main contact surface area of the first electrode comprises a plurality of concentric circles each being in space relationship with respect to each other and at least one conductive path being provided between each of the plurality of concentric circles.

4. The electrochemical cell as in claim 3, wherein each of the electrodes further comprises a lead portion providing a conductive path to the main contact surface area.

5. The electrochemical cell as in claim 3, wherein the at least one conductive path is a pair of conductive paths arranged on the main contact surface area such that a length of any one of a portion of the pair of conductive paths or a portion of any one of the plurality of concentric circles is reduced.

6. The electrochemical cell as in claim 1, wherein the first electrode is a reference electrode.

7. The electrochemical cell as in claim 1, wherein the first electrode is a reference electrode.

8. A gas sensor, comprising:
an electrochemical cell, the electrochemical cell comprising:
an electrolyte having a first active exterior surface and a second active exterior surface aligned with the first active exterior surface;
a first electrode having a main contact surface area disposed on the first active exterior surface of the electrolyte, wherein the main contact surface area of the first electrode defines a conductive path that does not completely cover the first active exterior surface;
a second electrode disposed on the second active exterior surface of the electrolyte, the second electrode being positioned to be in fluid communication with a gas; and
wherein, the electrochemical cell's resistance to oxygen ions is less than an electrochemical cell having a pair of electrodes configured to cover a greater percentage of the first and second active exterior surface areas.

9. The gas sensor as in claim 8, wherein the second electrode has a main contact surface area disposed on the second active exterior surface of the electrolyte, wherein the main contact surface area of the second electrode defines a conductive path that does not completely cover the second active exterior surface.

10. The gas sensor as in claim 9, wherein the main contact surface area of the first electrode comprises a plurality of concentric circles each being in space relationship with respect to each other and at least one conductive path being provided between each of the plurality of concentric circles.

11. The gas sensor as in claim 10, wherein each of the electrodes further comprises a lead portion providing a conductive path to the main contact surface area.

12. The gas sensor as in claim 10, wherein the at least one conductive path is a pair of conductive paths arranged on the main contact surface area such that a length of any one of a portion of the pair of conductive paths or a portion of any one of the plurality of concentric circles is reduced.

13. The gas sensor as in claim 8, wherein the first electrode is a reference electrode.

14. The gas sensor as in claim 8, further comprising a heating element.

15. The gas sensor as in claim 8, further a fluid path for allowing a reference gas to be in fluid communication with the first electrode.

16. A method for reducing the resistance of an electrochemical cell in a gas sensor, the method comprising:
positioning an electrolyte having a first active exterior surface and a second active exterior surface aligned with the first active exterior surface between a first electrode and a second electrode, the first electrode having a main contact surface area disposed on the first active exterior surface of the electrolyte, wherein the main contact surface area of the first electrode defines a conductive path that does not completely cover the first active exterior surface and the second electrode is disposed on the second active exterior surface of the electrolyte, the second electrode being configured to be positioned in fluid communication with a gas; and
wherein, the electrochemical cell's resistance to oxygen ions is less than an electrochemical cell having a pair of electrodes configured to cover a greater percentage of the first and second active exterior surface areas.

17. The method as in claim 16, wherein the second electrode has a main contact surface area disposed on the second active exterior surface of the electrolyte, wherein the main contact surface area of the second electrode defines a conductive path that does not completely cover the second active exterior surface.

18. The method as in claim 17, wherein the main contact surface area of the first electrode comprises a plurality of concentric circles each being in space relationship with respect to each other and at least one conductive path being provided between each of the plurality of concentric circles.

19. The method as in claim 18, wherein each of the electrodes further comprises a lead portion providing a conductive path to the main contact surface area.

20. The method as in claim 18, wherein the at least one conductive path is a pair of conductive paths arranged on the main contact surface area such that a length of any one of a portion of the pair of conductive paths or a portion of any one of the plurality of concentric circles is reduced.
